(19) United States
(12) Patent Application Publication
(10) Pub. No.: US 2018/0253715 A1
(43) Pub. Date: Sep. 6, 2018

(54) DRIVER ASSISTANCE SYSTEM

(71) Applicant: FORD MOTOR COMPANY, Dearborn, MI (US)

(72) Inventors: Michael Peter LOEFFLER, Bergisch Gladbach NRW (DE); Thomas BIRKENBEIL, Hennef NRW (DE)

(73) Assignee: FORD MOTOR COMPANY, Dearborn, MI (US)

(21) Appl. No.: 15/910,780

(22) Filed: Mar. 2, 2018

(30) Foreign Application Priority Data
Mar. 2, 2017 (DE) 10 2017 203 375.4

(51) Int. Cl. G06Q 20/32; G08G 1/14; G01C 21/36; G06Q 10/02

(52) U.S. Cl. CPC G06Q 20/322; G08G 1/143; G06Q 20/40145; G06Q 10/02; G01C 21/3697

(57) ABSTRACT

A driver assistance system supports a driver of a vehicle during a parking procedure. Using the driver assistance system, automatic display and finding an available parking space is performed at a desired destination, automatic transfer to a memory of data relating to the vehicle position is performed after carrying out the parking procedure, wherein these data are retrievable by a mobile communication device of the driver to relocate the vehicle, and automatic payment for the parking procedure is performed before the vehicle drives out of a parking area, which has the parking space.

### CROSS-REFERENCE TO RELATED APPLICATIONS

This application claims foreign priority benefits under 35 U.S.C. § 119(a)-(d) to DE Application 10 2017 203 375.4 filed Mar. 2, 2017, which is hereby incorporated by reference in its entirety.

### TECHNICAL FIELD

The disclosure relates to a driver assistance system to support the driver of a vehicle during a parking procedure.

### BACKGROUND

Finding an available and low-cost parking space often represents a difficult task, particularly in an unfamiliar city, and can result in high stress levels and also critical traffic situations. Modern navigation systems normally provide information relating to parking spaces available in the vicinity of the destination, but not relating to the availability of free parking spaces. Special applications for mobile terminals are already available on the market, which indicate the multistory car parks present in a selectable city, parking charges and further details. A navigation to these parking spaces is also possible by further apps. However, the vehicle's on-board navigation system cannot currently provide the combined package of the above-mentioned functions.

Furthermore, even after finding an available parking space and parking the vehicle, it may prove difficult for a driver to relocate his vehicle after a lengthy period. Even if it was still comparatively simple to find the multistory car park, it is often difficult to remember a level concerned, a respective section and a precise parking space number of the parking space concerned where the vehicle was parked. Various applications or “apps” available on the market require manual storage of the vehicle position when leaving the vehicle. Furthermore, applications are also available in which GPS data are used to locate the vehicle. However, the problem may occur, in a multistory car park with a plurality of levels, that a vehicle cannot be located due to the unavailability of GPS signals within the building.

Furthermore, situations occur in practice in which the driver of a vehicle must make payment for services or goods while he is in the vehicle, e.g. when driving out of a multistory car park, when paying for meals in drive-in restaurants or when leaving a car wash. Further possible scenarios are e.g. payment for a charging procedure of an electric vehicle or the payment for a refueling procedure. Customary payment methods via cash, credit card or using mobile devices can also turn out to be very inconvenient in certain situations, for example if the necessary object (such as a wallet) is not to hand (e.g. is located in a handbag or on the rear seat). In addition, the necessary opening of the window (e.g. to reach a terminal) may also be inconvenient depending on the ambient conditions (heat, cold, rain, air pollution, etc.) and furthermore entails an increased risk of theft in respect of Smartphones, wallets, and other items. Necessary maneuvering procedures with which the vehicle is driven close enough to a terminal or the like entail the risk of minor collisions with the infrastructure concerned. Last but not least, manual actuation of a terminal or handling of coins and banknotes may also be unwanted from a hygiene perspective. In addition, cash payment abroad also requires availability of cash in the respective national currency.

### SUMMARY

One object of the present disclosure is to provide a driver assistance system to support a driver of a vehicle during a parking procedure, which, particularly in a downtown environment for a driver without local knowledge, enables a final phase of a journey up until the parking procedure, including a phase of setting off once more, to be designed as safe and convenient.

A driver assistance system according to the disclosure to support the driver of a vehicle during a parking procedure is configured to carry out the following steps:

automatic display of available parking spaces at a desired destination;

automatic navigation to an available parking space at a desired destination;

automatic transfer to a memory of data relating to a vehicle position after carrying out a parking procedure, wherein these data are retrievable by a mobile communication device of the driver for relocating the vehicle; and

automatic payment for the parking procedure before the vehicle drives out of a parking area, which has the parking space.

According to the disclosure, a synergy effect is created through an interworking of a plurality of functionalities, insofar as the functionalities of parking space finding or guidance, a parking charge payment and relocation of the vehicle are combined with one another in a suitable manner and thus, particularly in a downtown environment for a driver who is possibly without local knowledge, the final phase of a journey up until the parking procedure (“last mile”), including the phase of setting off once more after carrying out the parking procedure, is similarly designed to be safe and convenient.

The disclosure contains, in particular, a concept of providing increased security and also user-friendliness and convenience through integration of parking space or multistory car park information into the vehicle navigation system by displaying, e.g. via a pop-up window, the multistory car parks or parking spaces located in the current surroundings on reaching a destination, wherein tan availability and a price per hour of the parking space use are additionally displayed. The route guidance can then be automatically started when one of the displayed multistory car parks is selected. As an additional function, the user can be given facility to reserve a parking space directly via a user interface of the vehicle, thereby ensuring that he also obtains a free parking space on arrival at the multistory car park concerned.

According to the disclosure, a contactless communication can be implemented between a POS terminal (POS=“Point of Sale”) and the vehicle via a radiofrequency identification (RFID=“Radio Frequency Identification”) over an extended distance (typically a distance of several meters instead of a few centimeters as in currently customary near-field communication). The driver does not have to extend his arm physically into an area outside the vehicle, but receives information relating to a payment transaction concerned on a central display inside the vehicle. Since a range of the system according to the disclosure is long enough to enable a correct function during movement of the vehicle at low speed, there is no need to maneuver the vehicle at a distance of an arm's length from the POS terminal concerned. In addition, an increased security standard can be achieved by enabling an identification of the driver in the authorization of the payment procedure. A fingerprint recognition, for example, can be used here. The identification concerned can also be used in the retrieval of driver-specific settings of vehicle seats, mirrors, displays, passenger compartment air conditioning, etc.

According to one embodiment, the driver assistance system is configured to request a reservation of a found parking space automatically or in response to a driver input.

According to one embodiment, the driver assistance system is configured to start a route guidance to the parking area, which has a parking space after an available parking space has been found.

According to one embodiment, the driver assistance system is configured to forward information relating to costs incurred in using the parking space automatically to the driver.

According to one embodiment, the driver assistance system is configured to carry out automatic payment for the parking procedure using a wireless RFID communication.

According to one embodiment, the driver assistance system is configured to carry out automatic payment for the parking procedure using a fingerprint recognition.

According to a further advantageous design, additional information is displayed with automatic display of available parking spaces. This additional information may be all information useful in connection with the parking space, which may be relevant to a decision in favor of this parking space. This includes additional information indicating whether the parking space is located in a multistory or underground car park, whether the parking space is under cover over the vehicle or is located outdoors. Additional information may be a distance from the parking space to an exit, parking charges, availability, a total number of parking spaces in this area, a number of available parking spaces, dimensions of the parking spaces, accessibility of the parking spaces, restrictions affecting the parking spaces, opening times, and possible toilet access. The list of these additional information elements is not exhaustive, and further relevant information may be displayed here, in any combination.

The disclosure is explained in detail below on the basis of example embodiments with reference to the attached figures. In the drawings:

### BRIEF DESCRIPTION OF THE DRAWINGS

FIG. 1 shows a flow diagram to explain a typical scenario in the operation of the driver assistance system according to the disclosure;

FIG. 2 shows a flow diagram for the detailed explanation of an automatic payment procedure carried out according to the disclosure;

FIG. 3 shows a flow diagram to explain a communication according to the disclosure between a vehicle and an infrastructure of a parking area or multistory car park; and

FIG. 4 shows a block diagram to illustrate communication shown in FIG. 3.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

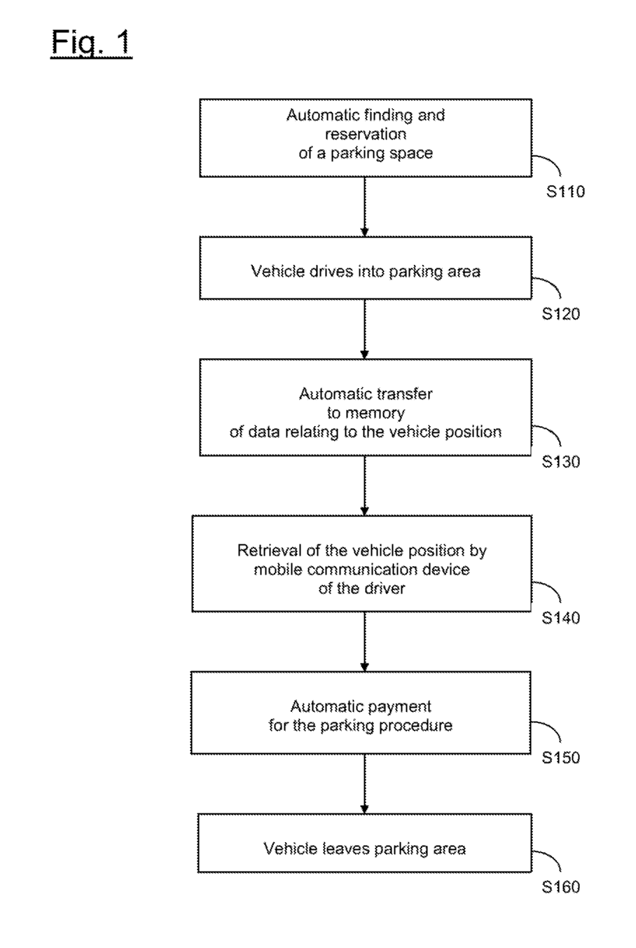

FIG. 1 shows a flow diagram to explain a typical scenario in an operation of a driver assistance system according to the disclosure;

In step S110, an automatic display of parking spaces, including their characteristics, is performed, along with finding and reserving a selected parking space. In step S120, a vehicle drives into a parking area (e.g. a multistory car park) that has the selected parking space concerned. In step S130, data relating to a vehicle position are transferred automatically to a memory. In step S140, the vehicle position is retrieved via a mobile communication device of a driver. In step S150, payment is made via fingerprint identification. In step S160, the vehicle leaves the parking area.

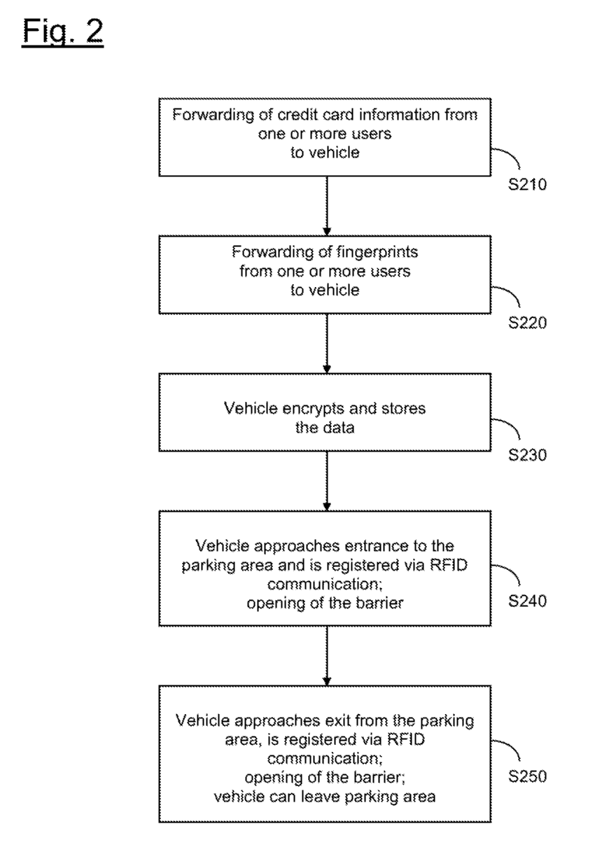

The performance of a payment procedure inside a vehicle according to one embodiment is presented in more detail in the flow diagram shown in FIG. 2. In a step S210, credit card information or payment card information is forwarded from a vehicle user wishing to make use of a service to a vehicle. Furthermore, in step S220, fingerprints of all users are forwarded to the vehicle in order to enable an unequivocal matching between a credit card and a user, and corresponding data are encrypted and stored by the vehicle in step S230.

In a step S240, the vehicle approaches an entrance to the parking area or multistory car park, the vehicle is registered via an RFID communication and a barrier is opened. In a step S250, the vehicle (after carrying out a parking procedure) approaches an exit of the parking area or multistory car park, the payment procedure is carried out via a POS terminal, and the barrier is opened and the vehicle can leave the parking area.

According to the disclosure, a novel and sophisticated communication between the vehicle and the infrastructure of the multi-story car park can be used, as described below. To do this, when a multistory car park is used, information relating to an address of the multistory car park, a level and number of parking spaces, and also an arrival time can first be transmitted from a parking space recognition to the vehicle in order to enable a calculation of the expected parking charge. This information is stored in the vehicle and can be retrieved on demand. Even after a lengthy parking duration (e.g. at the end of a two-week holiday), it is then simple to relocate the vehicle. The same RFID interface can be used as was already used in the previously described performance of payment procedures.

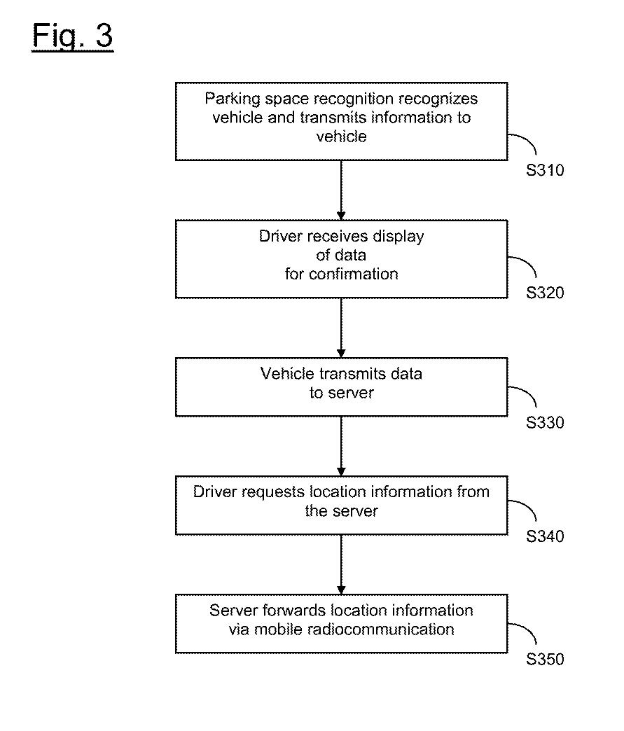

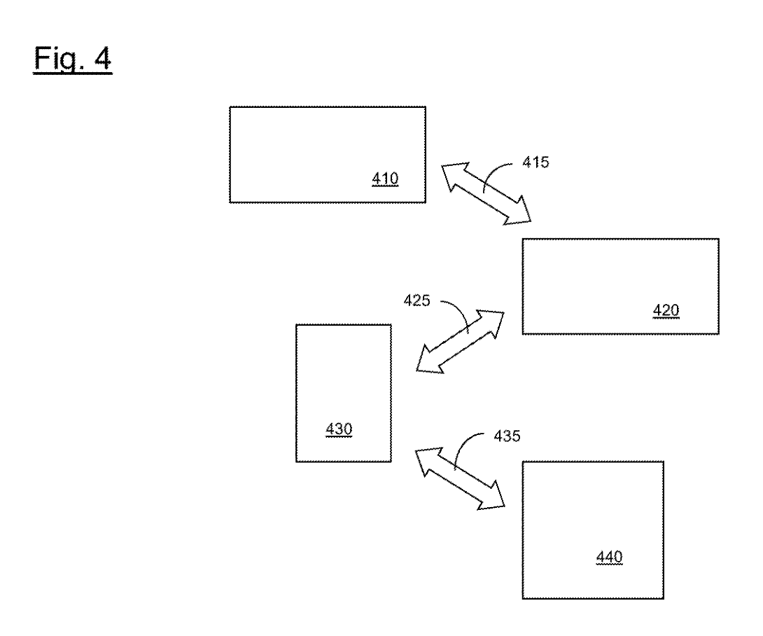

A possible sequence of a method according to the disclosure is explained below with reference to the flow diagram shown in FIG. 3 and the block diagram shown in FIG. 4. A novel and sophisticated communication between the vehicle and the infrastructure of the parking area (e.g. multistory car park) is used here:

According to FIG. 3, recording or recognizing of the vehicle (denoted “420” in FIG. 4) through parking space recognition (denoted “410” in FIG. 4), and transferring relevant information to the vehicle, wherein this information may comprise, for example, an address of the parking area or multistory car park, a level or number of the parking space and an arrival time of the vehicle in the parking area (in order to enable a calculation of the parking charge incurred) is performed in a first step S310. The corresponding wireless communication is denoted “415” in FIG. 4. This information can be stored in the vehicle so that the driver can retrieve it later, on demand. In step S320, the driver receives a pop-up message on a display with all data for confirmation of the latter, as a result of which an input of the data from other, possibly simultaneously forwarded, parking space recognitions can be prevented. Following confirmation of the data, the parking space recognition stops a transmission procedure to avoid a misinterpretation by other vehicles. In a step S330, the vehicle transmits the data to a server (denoted “430” in FIG. 4), where they are stored until the user next moves the vehicle. This communication (performed via mobile radiocommunication) is denoted “425” in FIG. 4. In step S340, the user requests location information from the server. In step S350, the server forwards the information concerned via mobile radiocommunication to the driver or to a communication device (denoted “440” in FIG. 4) carried by said driver. The corresponding communication is denoted “435” in FIG. 4.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A driver assistance method comprising:
automatically displaying, on a vehicle display, a parking area having parking spaces at a desired destination;
automatically transferring, to a memory, data relating to a vehicle position responsive to completing a parking procedure such that the vehicle position occupies a parking space of the parking spaces, wherein the vehicle position is retrieved by a mobile communication device such that the driver is notified of the vehicle position on the mobile communication device; and
automatically paying for parking at the desired destination before the vehicle exits the parking area.

2. The driver assistance method as claimed in claim 1 further comprising requesting a reservation of the parking space from the parking spaces at the desired destination in response to a driver input.

3. The driver assistance method as claimed in claim 1 further comprising starting a route guidance to the parking area which has the parking space responsive to an available parking space being found.

4. The driver assistance method as claimed in claim 1 further comprising forwarding information relating to costs incurred in using the parking space automatically to the mobile communication device.

5. The driver assistance method as claimed in claim 1, wherein automatically paying the desired destination uses wireless Radio Frequency Identification (RFID) communication.

6. The driver assistance method as claimed in claim 1, wherein automatically paying the desired destination is performed by using fingerprint recognition.

7. The driver assistance method as claimed in claim 1 further comprising displaying additional information while automatically displaying the parking area.

8. The driver assistance method as claimed in claim 7, wherein the additional information includes at least one of a multistory car park, an underground car park, a parking space under cover, an outdoor parking space, a distance to an exit, parking charges, availability, a number of parking spaces, a number of available parking spaces, dimensions of the parking spaces, accessibility of the parking spaces, restrictions affecting the parking spaces, opening times, or toilet access.

9. A vehicle comprising:
a navigation system configured to automatically display, on a vehicle display, a parking area having parking spaces at a desired destination;
a memory unit configured to automatically transfer data relating to a vehicle position responsive to completion of a parking procedure such that the vehicle position occupies a parking space of the parking spaces to a mobile communication device, wherein the vehicle position is retrieved by the mobile communication device such that a driver is notified of the vehicle position on the mobile communication device; and
a Radio Frequency Identification wireless communication system configured to automatically pay the desired destination charges relating to the parking procedure before the vehicle exits the parking area.

10. The vehicle as claimed in claim 9, wherein the navigation system is further configured to request a reservation of the parking space in the parking area at the desired destination in response to a driver input.

11. The vehicle as claimed in claim 10, wherein the navigation system is further configured to start route guidance to the parking area in response to the reservation.

12. The vehicle as claimed in claim 9, wherein the memory is further configured to forward information relating to costs incurred in using the parking space to the mobile communication device.

13. The vehicle as claimed in claim 9, wherein the RFID wireless communication system uses fingerprint recognition to pay the desired destination for the parking space.

14. The vehicle as claimed in claim 9, wherein the navigation system is further configured to display additional information indicative of an accessibility of the parking space while the parking area is displayed.

15. A driver assistance system comprising:
a navigation system that displays an area having parking spaces at a destination;
a memory that transfers data indicative of a vehicle position occupying a space in the area after a parking procedure to a mobile device, wherein a driver is notified of the vehicle position on the mobile device; and
a communication system that pays the destination charges relating to the parking procedure before exiting the area.

16. The driver assistance system as claimed in claim 15, wherein the navigation system requests a reservation of the space in the area at the destination in response to a driver input.

17. The driver assistance system as claimed in claim 16, wherein the navigation system starts route guidance to the area in response to the reservation.

18. The driver assistance system as claimed in claim 15, wherein the memory forwards information relating to costs incurred in using the space to the mobile device.

19. The driver assistance system as claimed in claim 15, wherein the communication system uses fingerprint recognition to pay the destination for the space.

20. The driver assistance system as claimed in claim 15, wherein the navigation system displays additional information indicative of restrictions that affect the space while the area is displayed.
